(19) United States
(12) Patent Application Publication
(10) Pub. No.: US 2013/0141070 A1
(43) Pub. Date: Jun. 6, 2013

(54) CONTROL SYSTEM AND METHOD FOR SHARED INDUCTOR REGULATOR

(71) Applicants: Andrew D. Goessling, Boston, MA (US); Weihong Qiu, San Jose, CA (US); Zaki Moussaoui, San Carlos, CA (US)

(72) Inventors: Andrew D. Goessling, Boston, MA (US); Weihong Qiu, San Jose, CA (US); Zaki Moussaoui, San Carlos, CA (US)

(73) Assignee: INTERSIL AMERICAS LLC, Milpitas, CA (US)

(21) Appl. No.: 13/427,224

(22) Filed: Mar. 22, 2012

Related U.S. Application Data
(60) Provisional application No. 61/565,700, filed on Dec. 1, 2011.

(51) Int. Cl. G05F 1/10

(52) U.S. Cl. 323/284

(57) ABSTRACT

A control system and method for a shared inductor regulator. The regulator includes an inductor and multiple switches to selectively couple the inductor to output, reference and charge nodes. The charge node may be coupled to a battery. An input switch may be included to selectively couple the inductor to a source node. A controller controls the switches to regulate output voltage, charge current, and a source voltage when provided. The inductor current is sensed and used to regulate the output voltage, and to regulate either the charge current or the input voltage. When an external source provides sufficient power, the charging current is regulated. When the source reaches a maximum power set point, the input voltage is maintained at a minimum level. When the source provides insufficient power, the battery is used to add power or to provide sole power.

### CROSS-REFERENCE TO RELATED APPLICATIONS

This application claims the benefit of U.S. Provisional Application Ser. No. 61/565,700, filed on Dec. 1, 2011, which is hereby incorporated by reference in its entirety for all intents and purposes.

### BRIEF DESCRIPTION OF THE DRAWINGS

The benefits, features, and advantages of the present invention will become better understood with regard to the following description, and accompanying drawings where:

FIG. 1 is a simplified block diagram of an electronic device configured with a power system including a shared inductor regulator implemented according to an embodiment of the present invention;

FIG. 2 is a simplified schematic and block diagram of the shared inductor regulator of FIG. 1 implemented according to one embodiment of the present invention including a shared inductor;

FIG. 3 is a graphic diagram illustrating operation of the regulator of FIG. 2 according to a first operating mode (MODE 1) which is operative when the external power source of FIG. 2 has more than enough power to regulate both the output voltage and the charging current;

FIG. 4 is a graphic diagram illustrating operation of the regulator of FIG. 2 according to a second operating mode (MODE 2) which is operative when the external power source of does not have sufficient power to regulate both the output voltage and the charging current;

FIG. 5 is a graphic diagram illustrating operation of the regulator of FIG. 2 according to a third operating mode (MODE 3) which is operative when the external power source does not have sufficient power to regulate the output voltage;

FIG. 6 is a graphic diagram illustrating operation of the regulator of FIG. 2 according to a fourth operating mode (MODE 4) which is operative when the external power source of FIG. 2 is absent, disconnected or otherwise non-functional;

FIG. 7 is a graphic diagram illustrating operation of the regulator of FIG. 2 according to a fifth operating mode (MODE 5) which is a special mode that is used during low output loads when the output current is small relative to the charging current;

FIG. 8 is a schematic diagram of an exemplary embodiment of the low block of FIG. 2 according to one embodiment;

FIG. 9 is a simplified schematic and block diagram of a regulator implemented according to another embodiment in which the charge storage device is a capacitor;

FIG. 10 is a simplified schematic diagram of the compensation block of FIG. 2 according to one embodiment; and

FIG. 11 is a simplified schematic and block diagram of the controller of FIG. 2 according to one embodiment.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

A conventional switch mode voltage regulator may include multiple inductors, such as at least one inductor per output. In one conventional configuration, one inductor is provided to charge a battery from an external source, and another inductor is provided to regulate battery power to the load. Additional inductors occupy a large amount of space and increase cost for most applications.

A shared inductor regulator architecture as described herein integrates two or more voltage regulators with a single inductor, which results in space savings and cost reduction. A controller performs a time multiplex function of the inductor between an external power source (e.g., AC adapter) and a charge storage device (e.g., rechargeable battery) at the input, and between the charge storage device and the output. The charge storage device may be a capacitor or a battery, where the charge storage device may be configured either as an input or an output depending upon the presence and state of an external power source. At least one inductor is eliminated at the expense of additional switches. In one embodiment, the topology is inherently buck-boost and can generally handle almost any practicable combination of the input voltage (VIN), battery voltage (VBAT) and output voltage (VO). The switches and the inductor are each sized for the charge current requirement for any given configuration. The charge storage device may be a capacitor, in which the switches are controlled to achieve dual output voltages: one positive and another negative. The present disclosure describes control operation for a battery, in which the control scheme is modified if the charge storage device is a capacitor.

In one embodiment, the external power source provides the input voltage VIN at about 5 volts (V), the battery voltage VBAT ranges between 3 to 4.2V, and the output voltage VO is boosted to 20-30V. The external power source may operate within a voltage range, such as providing a nominal voltage level down to a minimum source level. In one embodiment, for example, the external power source provides a nominal voltage of 5V and has a minimum voltage level of about 4.5V. The shared inductor regulator detects if and when the source voltage falls to the minimum source level and then operates to regulate the input to maintain the minimum source level.

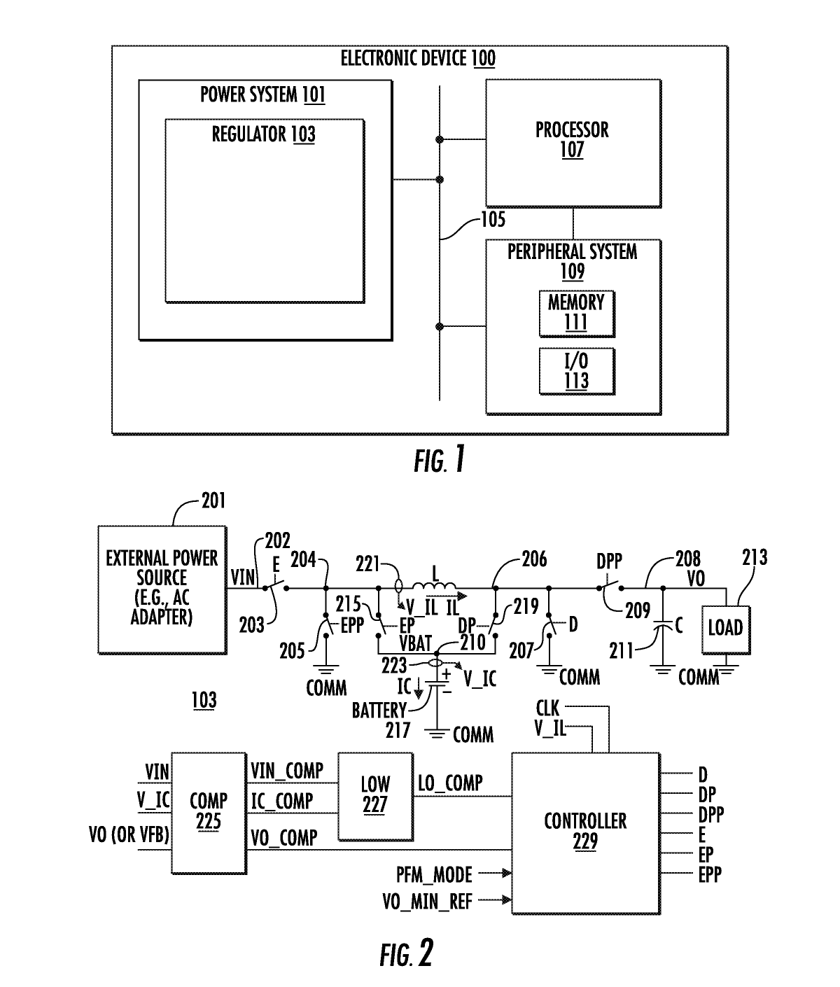

FIG. 1 is a simplified block diagram of an electronic device 100 configured with a power system 101 including a shared inductor regulator 103 implemented according to an embodiment of the present invention. The power system 101 develops one or more supply voltages which provide power to other system devices of the electronic device 100. In the illustrated embodiment, the electronic device 100 includes a processor 107 and a peripheral system 109, both coupled to receive supply voltages from the power system 101 via a bus 105, which includes any combination of power and/or signal conductors. In the illustrated embodiment, the peripheral system 109 may include any combination of a system memory 111 (e.g., including any combination of RAM and ROM type devices and memory controllers and the like), and an input/output (I/O) system 113, which may include system controllers and the like, such as graphic controllers, interrupt controllers, keyboard and mouse controllers, system storage device controllers (e.g., controllers for hard disk drives and the like), etc. The illustrated system is exemplary only, since many of the processor system and support devices may be integrated onto the processor chip as understood by those skilled in the art.

The electronic device 100 may be any type of computer or computing device, such as a computer system (e.g., notebook computer, desktop computer, netbook computer, etc.), a media tablet device (e.g., iPad by Apple Inc., Kindle by Amazon.com, Inc., etc.), a communication device (e.g., cellular phone, smartphone, etc.), among other type of electronic devices (e.g., media player, recording device, etc.). The power system 101 may be configured to include a battery (rechargeable or non-rechargeable) and/or may be configured to operate with an alternating current (AC) adapter or the like.

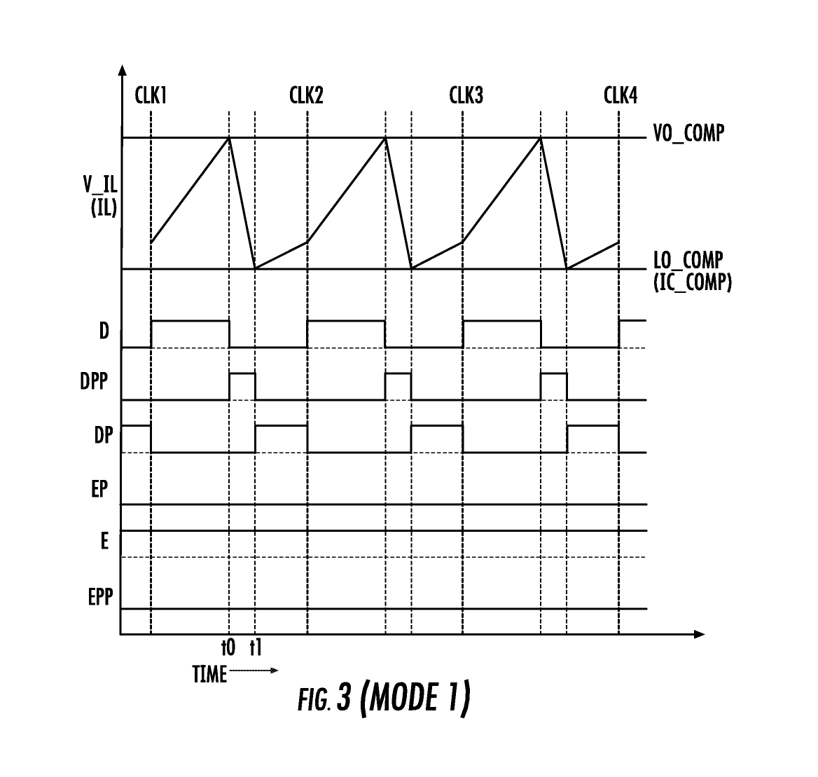

FIG. 2 is a simplified schematic and block diagram of the regulator 103 implemented according to one embodiment of the present invention including a shared inductor L. An external power source 201 provides a DC (direct current) input voltage VIN on a source node 202. The external power source 201 may be of any type, such as, for example, an AC adapter which converts an AC voltage to the DC input voltage VIN. A switch 203 has switched terminals coupled between input node 202 and an input node 204 and is controlled by a signal E. Another switch 205 has switched terminals coupled between input node 204 and a reference or common node COMM and is controlled by a signal EPP. It is noted that COMM generally represents one or more reference nodes, including one or more ground levels or nodes, such as signal ground, power ground, chassis ground, etc., or any other suitable reference voltage level. COMM is shown in simplified form as a single reference node for clarity of illustration. The inductor L is coupled between input node 204 and an intermediate node 206, and another switch 207 has its switched terminals coupled between node 206 and COMM and is controlled by a signal D. Another switch 209 has its switched terminals coupled between node 206 and an output node 208 and is controlled by a signal DPP. The output node 208 develops a regulated output voltage VO. An output capacitor 211 with capacitance C is coupled between the output node 208 and COMM, and a load 213 is also coupled between output node 208 and COMM. The load 213 may represent any of the devices coupled to the bus 105, such as the processor 107 and/or any one or more of the devices of the peripheral system 109.

A switch 215 has its switched terminals coupled between node 204 and a charge node 210 and is controlled by a signal EP. A battery 217 is shown having its positive terminal coupled to node 210 and its negative terminal coupled to COMM. In this embodiment, the charge storage device coupled to the charge node 210 is the battery 217 so that node 210 develops the battery voltage VBAT. Another switch 219 has its switched terminals coupled between node 206 and the charge node 210 and is controlled by a signal DP. A current sensor 221 is provided for sensing current IL through the inductor L and for providing a voltage V_IL indicative thereof (e.g., proportional voltage signal or the like). The current sensor 221 represents any type of current sense system which may be used for sensing or otherwise deriving or determining the current level of IL for providing V_IL. Another current sensor 223 (or current sense system) is provided for sensing a charge current IC through the battery 217 and for providing a voltage V_IC indicative thereof (e.g., proportional voltage signal or the like). The current sensors 221 and 223 each represent current sense systems which may each be implemented in any one of many different manners as understood by those of ordinary skill in the art

Each of the switches 203, 205, 207, 209, 215 and 219 are shown as single-pole single-throw (SPST) switches each controlled by a corresponding control signal, e.g., E, EPP, D, DPP, EP and DP, respectively. In one embodiment, each switch is opened when its corresponding control signal is asserted low and is closed when the corresponding control signal is asserted high. Each of the control switches may be implemented as an electronic switch, such as any suitable type of transistor, such as, for example, a metal-oxide semiconductor (MOS) transistor, a field-effect transistor (FET), a MOSFET, a bipolar junction transistor (BJT) and the like, an insulated-gate bipolar transistor (IGBTs) and the like, etc.

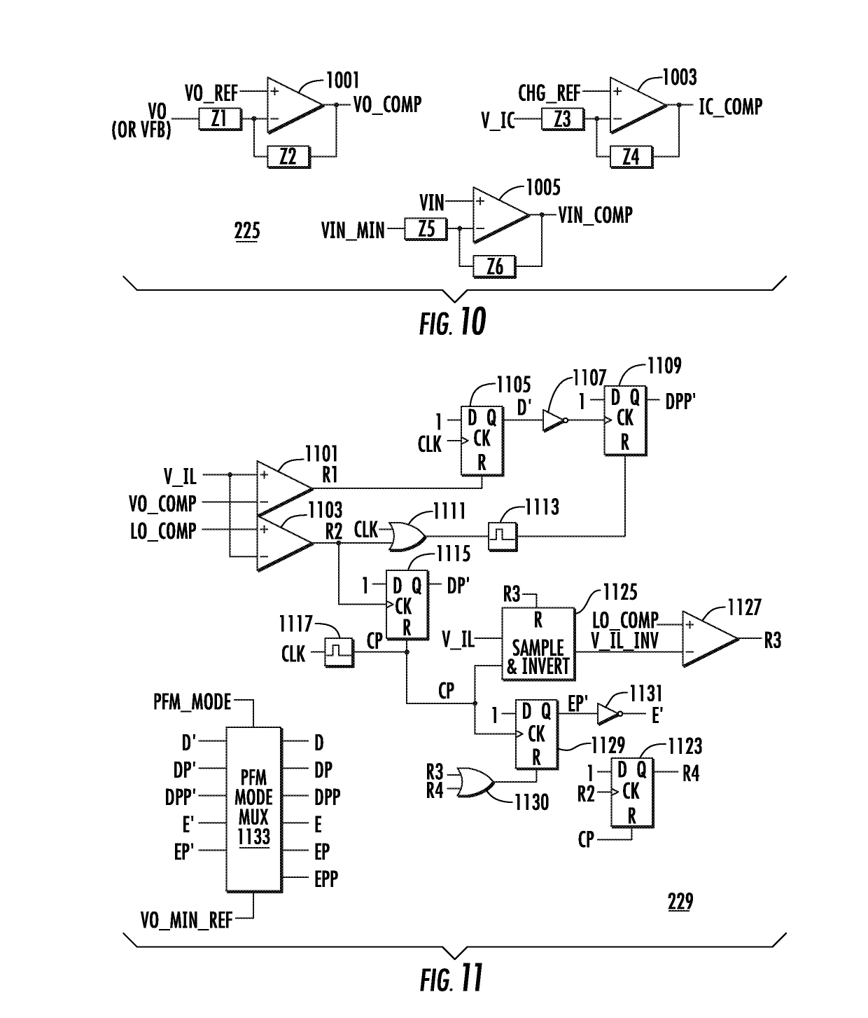

The regulator 103 is further shown including a compensation block 225 which includes compensation logic and/or circuitry for providing compensation signals. As shown, the compensation block 225 receives the input voltage VIN, the output voltage VO, and the voltage V_IC indicative of the battery charge current IC. The output voltage may be represented as a feedback voltage VFB, such as provided by a voltage divider circuit or the like (not shown). The compensation block 225 outputs corresponding compensation signals VIN_COMP indicative of an error relative to a desired level of VIN, IC_COMP indicative of an error relative to a desired level of charge current IC, and VO_COMP indicative of an error relative to a desired level of VO. Although shown as a single block, the compensation block 225 may be distributed as multiple compensation circuitry. Each compensation signal may be generated by an error amplifier circuit or the like (FIG. 10) as understood by those skilled in the art.

The VIN_COMP and IC_COMP signals are provided to respective inputs of a low block 227, which provides a low compensation signal LO_COMP at its output. LO_COMP is or otherwise represents the lower one of the VIN_COMP and IC_COMP signals. For example, the compensation signal VIN_COMP and IC_COMP having the lowest voltage level is provided as the LO_COMP voltage signal. The low block 227 may be implemented in any suitable manner, such as a comparator circuit or the like, or even as simple as a diode circuit (FIG. 8) in which LO_COMP is pulled to the lower voltage level of IC_COMP and VIN_COMP. As described further herein, the lower voltage compensation signal is used for controlling switching for each of multiple modes of operation.

LO_COMP, VO_COMP, V_IL and a clock signal CLK are provided to respective inputs of a controller 229, which develops and outputs the switch control signals E, EPP, EP, D, DPP and DP to the control inputs of the switches 203, 205, 215, 207, 209 and 219, respectively. The controller 229 is implemented according to a novel regulator and control scheme that is capable of providing the battery 217 with a regulated charging current and for regulating the output voltage VO from the external power source 201 (e.g., AC adapter) using only the sole inductor L. The control scheme also allows the battery 217 to smoothly transition from charging to providing power to the load 213 depending on the presence and state of the external power source 201. The control scheme further enables regulation of VIN from the external power source 201, if provided, to a minimum source level as further described herein. During this transition from the external power source 201 powering the output to the battery 217 powering the output, the controller 229 regulates the external input voltage to ensure optimum (e.g., maximum) power extraction.

As further described herein, there are at least two primary operating modes depending upon the operating conditions and four primary operating modes as described herein. At least one advantage of the control scheme described herein is that smooth operating transitions between the respective operating modes is achieved. An additional operating mode, referred to as a pulse frequency modulation (PFM) mode, may be implemented upon assertion of a PFM_MODE input signal provided to another input of the controller 229. The PFM mode is advantageous during a lower power mode when the load current ILD is relatively small compared to the charging current. In this case, the output voltage VO is generally regulated to maintain a minimum output voltage level VO_MIN and battery charge current is regulated to a desired level. A minimum output voltage reference value VO_MIN_REF is provided to another input of the controller 229 to regulate VO at VO_MIN.

In one embodiment, the control scheme is a current-mode control. There are at least three control parameters that are used to determine the switching conditions: an upper current threshold, a lower current threshold, and a clock transition. The control scheme attempts to regulate the inductor current IL within the upper and lower thresholds, and starts/ends each switching cycle according to the clock signal. There may exist several upper/lower current thresholds, which are determined by different regulation loops, like the VO voltage regulation loop, the input voltage/current regulation loop and the battery charging current regulation loop. The control scheme determines the proper loop output for the upper/lower threshold respectively based on the operational condition.

The upper current threshold may be controlled by the VO compensation much like traditional current-mode control. The lower current threshold may be controlled by the lower of the IC_COMP compensation and VIN_COMP. The IC_COMP compensation is controlled in such a way that when IC is below a charging current set point (e.g., CHG_REF, FIG. 10), the voltage of IC_COMP increases. The input voltage compensation is controlled in such a way that when VIN is below a minimum source level (e.g., VIN_MIN, FIG. 10) corresponding to a maximum power point (MPP) set point, the voltage of VIN_COMP decreases. When the external input voltage VIN is above VIN_MIN, VIN_COMP increases and IC_COMP controls the lower current threshold. When the external input voltage is below the MPP set point determined by VIN_MIN, VIN_COMP decreases and VIN_COMP controls the lower current threshold. The description herein is an example of how this type of control, together with the previously described architecture, may be utilized for a boost output.

FIG. 3 is a graphic diagram illustrating operation of the regulator 103 according to a first operating mode (MODE 1) which is operative when the external power source 201 has more than enough power to regulate both the output voltage VOUT and the charging current, in which case VIN is at or above VIN_MIN. In this case, the output voltage VO and the battery charging current IC are both regulated. The diagram plots V_IL (representing inductor current IL) and the control signals D, DPP, DP, EP, E and EPP versus time. The operative edges of the clock signal CLK occurs at regular intervals shown as CLK1, CLK2, CLK3, CLK4, etc. Each operative CLK edge may be a rising or falling edge depending upon the configuration. V_IL generally toggles between a low level set by LO_COMP and a high level set by VO_COMP. LO_COMP and VO_COMP are shown as non-varying horizontal levels, where it is understood that in an actual operating condition, these signals may vary over time. In MODE 1, when VO is too low, VO_COMP increases, and when IC is too low, IC_COMP increases.

In MODE 1, E remains high closing switch 203 so that the charge node 202 is shorted to the input node 204 so that VIN is provided to an input end of the inductor L. EP and EPP both remain low so that switches 215 and 205 both remain open. LO_COMP is controlled by IC_COMP since it is below VIN_COMP so that IC_COMP controls the lower current threshold of IL. The inductor waveform (illustrated by V_IL) dictates how the switching period between clock pulses is split between the output switches 207 (controlled by D), 219 (controlled by DP), and 209 (controlled by DPP). At CLK1, D goes high to turn on the low-side output switch 207 and the current IL ramps up until V_IL reaches or otherwise exceeds the upper threshold defined by VO_COMP at time t0. At t0, D is pulled low to open switch 207 and DPP is pulled high to turn on the output switch 209, so that the current IL ramps down. When V_IL reaches the lower threshold IC_COMP at time t1, DPP is pulled low to turn off switch 209 and DP is pulled high to turn on the charge switch 219 at time t1. DP remains high to keep switch 219 on until the next transition of CLK shown as CLK2. Operation repeats in substantially similar manner during subsequent clock cycles. It is noted that the current IL can ramp up or down during this period depending on the relative voltage of VIN and VBAT. The following figures illustrate exemplary waveforms in which the battery voltage VBAT is below the external input voltage VIN.

In MODE 1, the external power source 201 has sufficient power to provide target charge current to charge the battery 217 and to regulate the output voltage VOUT so that VIN remains at or above VIN_MIN. Thus, IC_COMP controls the lower current threshold of IL to regulate the battery charge current.

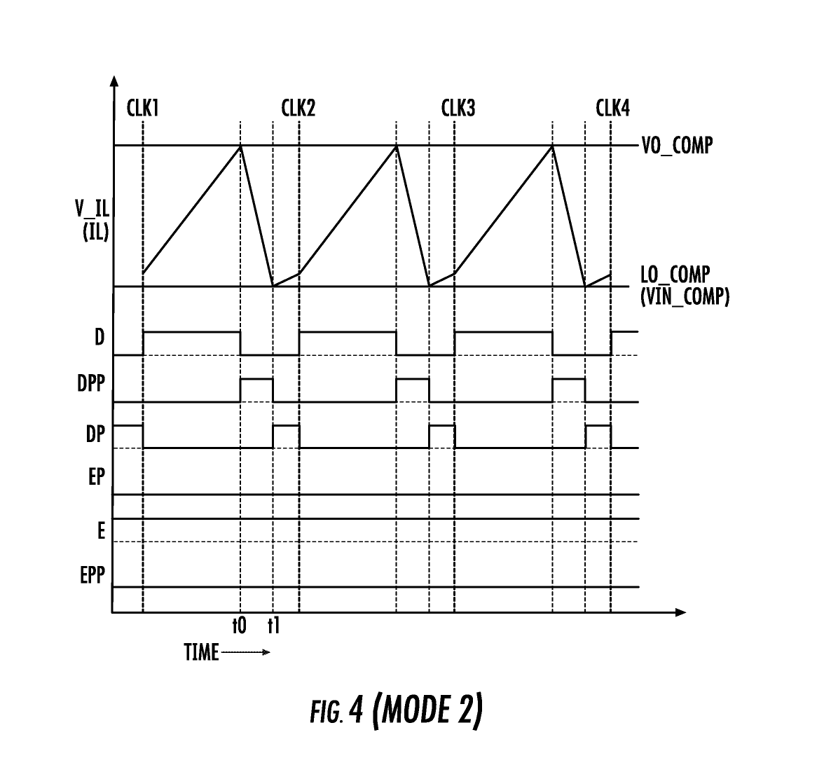

FIG. 4 is a graphic diagram illustrating operation of the regulator 103 according to a second operating mode (MODE 2) which is operative when the external power source 201 does not have sufficient power to regulate both the output voltage and the charging current. In this case, VIN decreases to VIN_MIN and is regulated at the MPP set point, VO is regulated and the battery 217 receives any excess energy that is not absorbed by the load 213. Again, V_IL (representing inductor current IL) and the control signals D, DPP, DP, EP, E and EPP are plotted versus time. The clock signal CLK goes high for operative edges at regular intervals shown as CLK1, CLK2, CLK3, CLK4, etc. V_IL generally toggles between a low level set by LO_COMP and a high level set by VO_COMP. LO_COMP and VO_COMP are shown as non-varying horizontal levels, where it is understood that in an actual operating condition, these signals may vary over time. In MODE 2, maximum power is obtained from the external power source 201 by an input voltage regulation loop. When VO is too low, VO_COMP increases. When VIN is too low, VIN_COMP decreases. The lesser of IC_COMP and VIN_COMP controls the lower threshold.

In MODE 2, the current waveform illustrated by V_IL and the switching periods are similar to that of MODE 1. D, DPP and DP are toggled in similar manner as in MODE 1, EP and EPP both remain low so that switches 215 and 205 both remain open, and E remains high so that switch 203 remains closed. The primary difference of MODE 2 relative to MODE 1 is that the lower current threshold LO_COMP is controlled by VIN_COMP in MODE 2 rather than IC_COMP (MODE 1). In MODE 2, the charge current is just at or below the target charge current level so that IC_COMP rises and the external power source 201 has reached the MPP (maximum output power of external power source 201). Thus, VIN decreases to at or below VIN_MIN, causing VIN_COMP to go below IC_COMP and control the lower current threshold for V_IL.

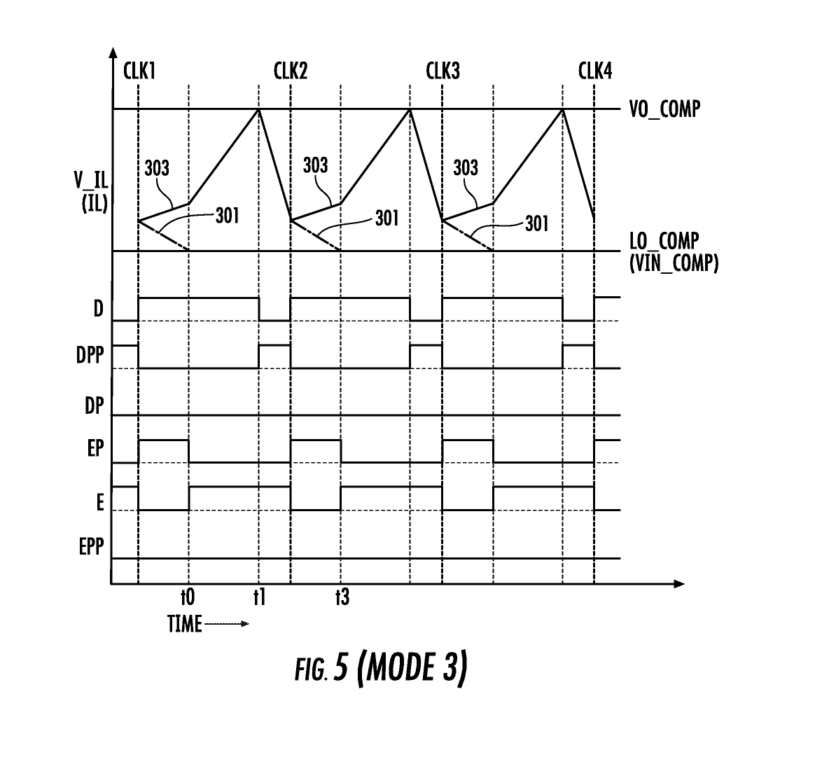

FIG. 5 is a graphic diagram illustrating operation of the regulator 103 according to a third operating mode (MODE 3) which is operative when the external power source 201 does not have sufficient power to regulate the output voltage VOUT. In this case, VIN is regulated to the MPP set point, VO is regulated and the battery 217 is used to provide additional power (e.g., discharged to the load 213). Again, V_IL (representing inductor current IL) and the control signals D, DPP, DP, EP, E and EPP are plotted versus time. The clock signal CLK goes high for operative edges at regular intervals shown as CLK1, CLK2, CLK3, CLK4, etc. V_IL generally toggles between a low level set by LO_COMP and a high level set by VO_COMP. LO_COMP and VO_COMP are shown as non-varying horizontal levels, where it is understood that in an actual operating condition, these signals may vary over time. In MODE 3, maximum power is obtained from the external power source 201 by an input voltage regulation loop. When VO is too low, VO_COMP increases. When VIN is too low, VIN_COMP decreases. The external power source 201 and the battery 217 share input period. The input switching condition is derived from inverted IL waveform and VIN_COMP.

In MODE 3, VIN_COMP is low enough (below IC_COMP) so that LO_COMP is dictated by VIN_COMP, and V_IL does not fall to the level of VIN_COMP before the assertion of CLK in each clock cycle. In this case, EPP remains low so that switch 205 remains opened, and DP also remains low so that switch 219 also remains opened. During the clock cycle between CLK1 and CLK2 at a time t0, EP goes low to open switch 215, and E goes high closing switch 203 to couple VIN to the inductor L and IL rises at a higher rate. D is high so that switch 207 is closed and DPP is low so that switch 209 is open. At subsequent time t1 during the first clock cycle, V_IL reaches VO_COMP, so that D goes low opening switch 207, and DPP goes high closing switch 209. The inductor current IL reverses so that V_IL ramps down from time t1 to the next clock edge at CLK2.

When the next clock edge arrives at CLK2, V_IL has not yet reached VIN_COMP. D is pulled high to turn back on the low-side output switch 207, and DPP is pulled back low to open switch 209. In this case, instead of coupling VIN, EP is pulled high to close switch 215 so that the battery voltage VBAT is coupled to the input-side of the inductor L. IL increases at a lower rate since supplied by the battery 217. An inverted current waveform shown by a dashed line 301 is an inverted version of V_IL (or of IL) shown at 303 while EP is high. In other words, the inverted current waveform 301 is a mirrored version (relative to horizontal) of V_IL shown at 303. In one embodiment, V_IL is sampled at each clock transition and the inverted current waveform is biased from this sample for the rest of the cycle. When the inverted current waveform 301 intersects the lower threshold VIN_COMP at time t3, EP is pulled low to open switch 215 and E is pulled high to close switch 203 so that VIN is again coupled to the inductor L. IL rises at a faster rate until it reaches VO_COMP as previously described. It is noted that the input side switching is independent from the output-side switching. Operation repeats in this same manner for each cycle of CLK.

In MODE 3, the external power source 201 is at its MPP set point and VIN is regulated to VIN_MIN. The external power source 201 does not have sufficient power for the load 213, so that switch 219 remains opened (DP low) and the battery 217 is not charged. Instead, switch 215 is multiplexed with switch 203 so that the battery 217 may source additional power to the load 213.

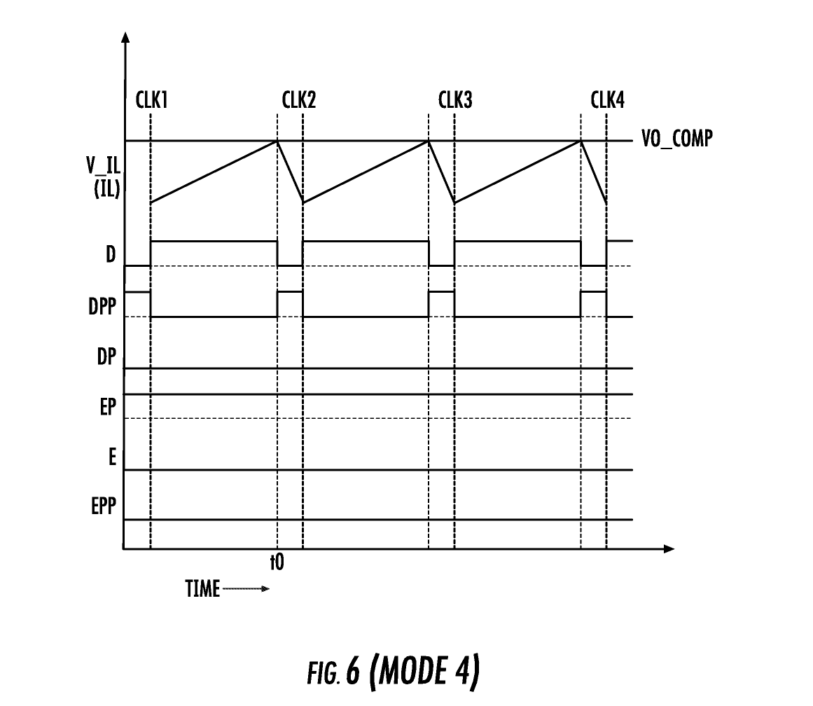

FIG. 6 is a graphic diagram illustrating operation of the regulator 103 according to a fourth operating mode (MODE 4) which is operative when the external power source 201 is absent, disconnected or otherwise non-functional. In this case, VO is regulated and the battery 217 is used to provide sole power (e.g., discharged to the load 213). Again, V_IL (representing inductor current IL) and the control signals D, DPP, DP, EP, E and EPP are plotted versus time. The clock signal CLK goes high at regular intervals shown as CLK1, CLK2, CLK3, CLK4, etc. V_IL generally toggles as controlled by CLK and the upper threshold level VO_COMP. VO_COMP is again shown as a non-varying signal, where it is understood that in an actual operating condition, it varies over time. In MODE 4, when VO is too low, VO_COMP increases. The battery 217 is used for input power to the load.

In MODE 4, since the external power source 201 is not available, VIN goes low to zero and VIN_COMP is so low that neither V_IL or its inverted version (inverted current waveform 301) intersect the lower threshold LO_COMP. In this case, E, EPP and DP remain low so that switches 203, 205 and 219 remain open. EP remains high to close switch 215 so that the VBAT from the battery 217 remains coupled to the input-side of the inductor L for the entire clock cycle. The output-side switches 207 and 209 are operated as a current-mode controlled boost. In particular, D is pulled high and DPP is pulled low at each operative clock edge so that switch 207 is closed and switch 209 is opened. During this time, IL rises. When V_IL reaches VO_COMP as shown at time t0, D is pulled low to open switch 207 and DPP is pulled high to close switch 209 and IL falls. At the next operative edge of CLK, D is pulled high and DPP is pulled low to repeat the cycle.

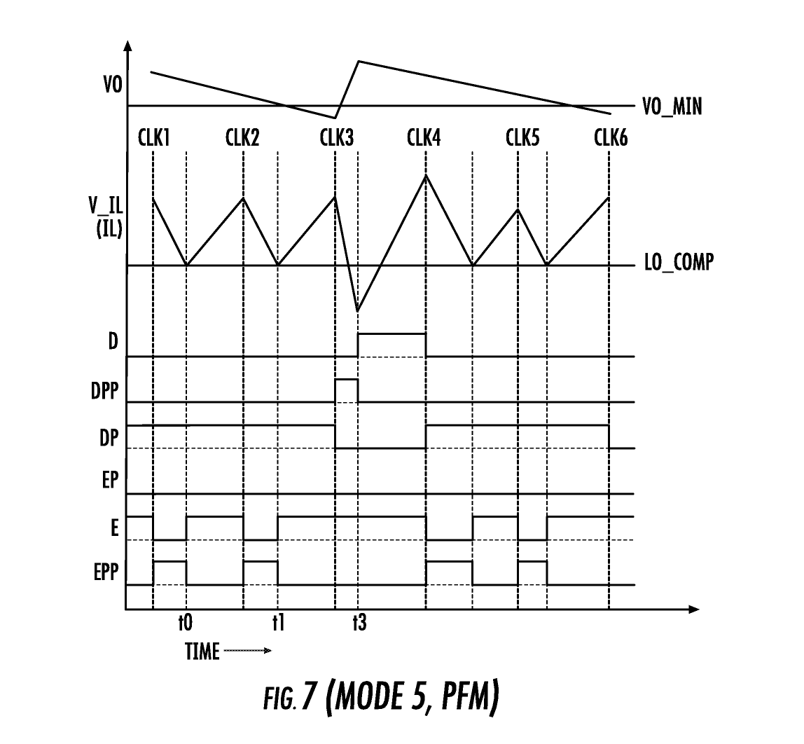

FIG. 7 is a graphic diagram illustrating operation of the regulator 103 according to a fifth operating mode (MODE 5) which is a special mode that is used during low output loads when the output current is small relative to the charging current. In this case, the PFM_MODE signal is asserted high, VO is regulated via PFM mode and either the battery current IC or the input voltage VIN is regulated to MPP depending upon which of IC_COMP or VIN_COMP is lower for controlling LO_COMP. Again, V_IL (representing inductor current IL) and the control signals D, DPP, DP, EP, E and EPP are plotted versus time. The clock signal CLK goes high for operative edges at regular intervals shown as CLK1-CLK6. V_IL generally toggles as controlled by CLK and the lower threshold level LO_COMP (lower of IC_COMP and VIN_COMP). During a low load condition, VO eventually falls to its lower threshold level shown as VO_MIN. Also plotted is VO relative to VO_MIN to illustrate operation when VO falls to or below VO_MIN. In MODE 5, buck operation is used to charge the battery 217 until VO drops below a minimum level, in which case a boost cycle is performed for one clock cycle, and then operation returns to buck mode.

In MODE 5 (PFM mode), the controller 229 operates the regulator as a current-mode control buck to charge the battery 217 and to periodically provide a pulse of current to the output. During buck operation, D, DPP and EP are low (so that switches 207, 209 and 215 are open) and DP is high to close switch 219. EPP goes high at each rising CLK edge to turn on the low-side input switch 205 and IL ramps down. When V_IL reaches the lower threshold LO_COMP (as shown at t0 during first clock cycle and t1 during second clock cycle), EPP is pulled low opening switch 205 and E is pulled high turning on the input switch 203 and IL ramps up until the next operative clock edge. At CLK3, however, VO has fallen below VO_MIN and the regulator 103 provides one boost cycle. During the boost cycle starting at CLK3, E remains high so that VIN remains coupled to the inductor L, DP is pulled low to open switch 219, and DPP is pulled high to close switch 209. This provides an output pulse which pulls VO above VO_MIN while IL (and this V_IL) drops.

It is noted that the on-time of the output pulse (duration of DPP being high) may be a fixed duration or is otherwise controlled adaptively to keep the pulse frequency within a desired band or frequency range. DPP is then pulled low to open switch 209 and D is pulled high to close switch 207 at time t3 while DP remains low keeping switch 219 open for the remainder of the cycle. Operation returns to buck operation at CLK4 in which D is pulled low and DP is pulled back high. Operation repeats in this manner in which buck mode remains the default mode until VO drops below VO_MIN for a boost cycle.

FIG. 8 is a schematic diagram of an exemplary embodiment of the low block 227 according to one embodiment. A source voltage level V+ is coupled through a resistor R to LO_COMP, which is further coupled to the anodes of a pair of diodes D1 and D2. IC_COMP is provided to the cathode of a first diode, e.g., D1, and VIN_COMP is provided to the cathode of the other diode, e.g., D2. Thus, LO_COMP is one diode drop higher that the lower voltage level of IC_COMP and VIN_COMP. The diode voltage drop differential is either negligible or otherwise compensated for by the compensation circuits (e.g., integration) associated with IC_COMP and VIN_COMP.

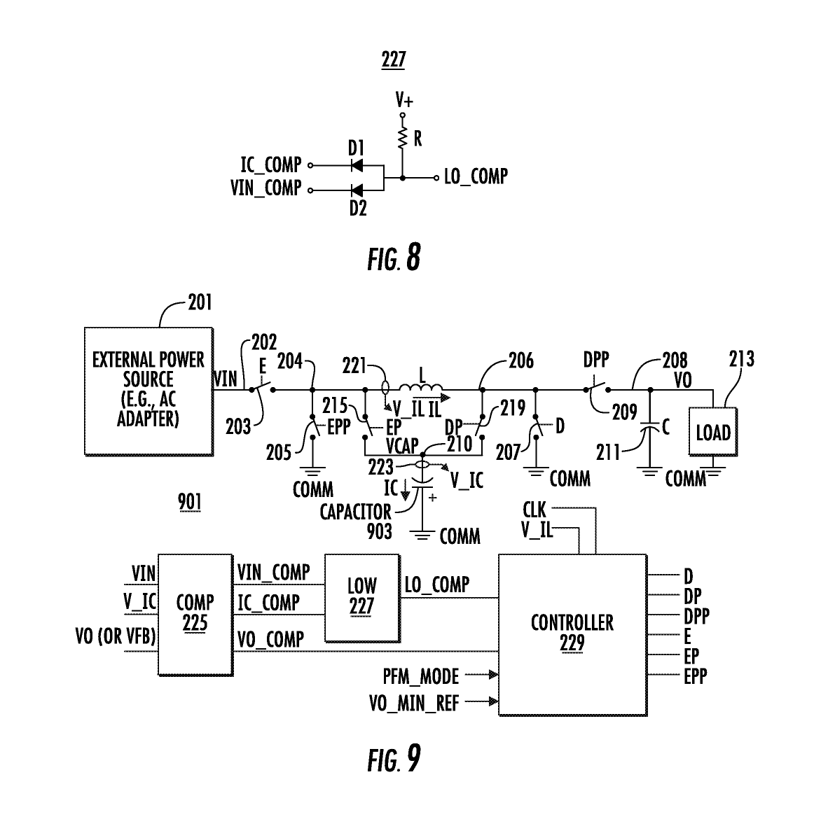

FIG. 9 is a simplified schematic and block diagram of a regulator 901 implemented according to another embodiment. Regulator 901 is substantially similar to regulator 103 in which similar components assume identical reference numbers. In the regulator 901, the battery 217 is replaced by a capacitor 903 as the charge storage device. The current sensor 223 senses current IC to the capacitor 903 and asserts a voltage V_IC. The charge node 210 develops a capacitor voltage VCAP rather than VBAT.

FIG. 10 is a simplified schematic diagram of the compensation block 225 according to one embodiment. The compensation block 225 includes three error amplifiers 1001, 1003 and 1005 for developing VO_COMP, IC_COMP and VIN_COMP used for regulating the output voltage VO, the charging current V_IC, and the input voltage VIN, respectively. Impedances Z1, Z2, Z3, Z4, Z5 and Z6 (Z1-Z6) each generally represent any one or a combination of passive electrical devices, such as resistors, capacitors and inductors, for loop compensation. The output voltage VO, or a representative feedback value VFB, is provided through Z1 to the inverting input of the error amplifier 1001, which receives VO_REF at its non-inverting input. Z2 is coupled between the inverting input and the output of the error amplifier 1001, and VO_COMP is provided at the output of the error amplifier 1001. VO_REF represents a target voltage level for regulating VO during normal operation. Thus, while VO is below VO_REF, VO_COMP rises to request an increase of VO, and when VO rises above VO_REF, VO_COMP decreases.

The charge current level indicated by V_IC is provided through Z3 to the inverting input of the error amplifier 1003, which receives CHG_REF at its non-inverting input. CHG_REF represents a desired charging current level for charging the charge storage device (e.g., for charging the battery 217). Z4 is coupled between the inverting input and the output of the error amplifier 1003, and IC_COMP is provided at the output of the error amplifier 1003. Thus, while V_IC is below CHG_REF, IC_COMP rises to request an increase of charging current, and when V_IC rises above CHG_REF, IC_COMP decreases.

The input voltage VIN is provided to the non-inverting input of the error amplifier 1005, and VIN_MIN is provided through Z5 to the inverting input of the error amplifier 1005. VIN_MIN represents the minimum level desired for VIN and also the MPP of the external power source 201. Z6 is coupled between the inverting input and the output of the error amplifier 1005, and VIN_COMP is provided at the output of the error amplifier 1005. Thus, when VIN is below VIN_MIN, VIN_COMP decreases in an attempt to control the loop to request an increase of the input voltage VIN. When VIN is above VIN_MIN, VIN_COMP increases.

FIG. 11 is a simplified schematic and block diagram of the controller 229 according to one embodiment. The schematic and block diagram of the controller 229 is simplified yet generally illustrates the functionality of the control method of the shared inductor regulator 103 according to an exemplary embodiment.

V_IL is provided to the non-inverting input of a comparator 1101 and to the inverting input of another comparator 1103. VO_COMP is provided to the inverting input of the comparator 1101 and LO_COMP is provided to the non-inverting input of the comparator 1103. The output of the comparator 1101 provides a signal R1, which is provided to the reset (R) input of a D-type latch 1105, which receives a logic “1” at its D input and the clock signal CLK at its clock (CK) input. The latch 1105 provides a signal D′ at its Q output to the input of an inverter 1107. The output of the inverter 1107 is coupled to the clock input of another D-type latch 1109, which receives a logic “1” at its D input and provides a signal DPP′ at its Q output.

The output of the comparator 1103 provides a signal R2, which is provided to one input of a 2-input logic OR gate 1111 and to the clock input of another D-type latch 1115. The OR gate 1111 receives CLK at its other input and has its output provided to the input of a pulse block 1113. The output of the pulse block 1113 is provided to the reset input of the latch 1109. CLK is provided to the input of another pulse block 1117, having its output providing a clock pulse signal CP to the reset input of the latch 1115. The output of the latch 1115 provides a signal DP′.

CP is provided to one input of a sample and invert block 1125 and to the clock input of another latch 1129. V_IL is provided to another input and a signal R3 is provided to a reset input of the sample and invert block 1125. The output of the sample and invert block 1125 provides an inverted V_IL signal, shown as V_IL_INV, to the inverting input of another comparator 1127, which receives LO_COMP at its non-inverting input and which provides the R3 signal at its output. The latch 1129 receives a logic “1” at its D input and provides a signal EP′ at its Q output. EP′ is provided to the input of an inverter 1131, which provides a signal E′ at its output. Another latch 1123 receives a logic “1” at its D input, receives the R2 signal at its clock input, receives CP at its reset input, and provides a signal R4 at its output. Another 2-input logic OR gate 1130 receives R3 and R4 at its inputs and has an output coupled to the reset input of the latch 1129.

The D′, DP′, DPP′, E′ and EP′ signals, and the PFM_MODE and VO_MIN_REF signals, are provided to respective inputs of a PFM mode multiplexer (MUX) 1133, which provides the D, DP, DPP, E, EP and EPP signals at corresponding outputs. During normal operation when not in the PFM mode, PFM_MODE is negated low and the D′, DP′, DPP′, E′ and EP′ signals are passed by the PFM mode MUX 1133 as the D, DP, DPP, E and EP signals, respectively, and EPP is held low (for MODEs 1-4). When PFM_MODE is asserted high, then logic circuitry (not show) within the PFM mode MUX 1133 alters operation according to the PFM mode shown in FIG. 7 and VO_MIN REF is used to detect when VO falls below VO_MIN. The PFM mode of operation is shown in FIG. 7 and is not further described.

Operation of the controller 229 as shown in FIG. 11 is now generally described with reference to the mode operation diagrams of FIGS. 3-6. It is assumed that PFM_MODE is negated low so that the D, DP, DPP, E, and EP signals are the same as the D′, DP′, DPP′, E′ and EP′ signals, respectively, and EPP remains low. The pulse blocks 1113 and 1117 operate in substantially the same manner. The output of the pulse block is normally low and remains low until a rising edge is detected at its input. When the input of a pulse block goes high, it momentarily pulses its output high for a sufficient duration to reset a latch or otherwise to be detected by other circuitry or logic as further described herein. In an alternative configuration, the CLK may be configured to pulse high during each cycle in which case the pulse blocks may be removed.

D (D′) is asserted high by latch 1105 upon each rising edge of CLK. When V_IL reaches VO_COMP, the comparator 1101 asserts R1 which resets the latch 1105 pulling D back low. When D goes low, latch 1109 pulls DPP (DPP′) high. If V_IL falls to LO_COMP before the next rising edge of CLK (MODEs 1 and 2), then R2 is asserted high by the comparator 1103 which resets the latch 1109 via OR gate 1111 and pulse block 1113 to pull DPP back low. Also when R2 goes high, latch 1115 pulls DP (DP′) high. When CLK next goes high, the pulse block 1117 resets latch 1115 to pull DP back low. If V_IL reaches LO_COMP just before or at about the same time as CLK is next asserted high, then DP is not asserted or otherwise asserted for a very short duration. Operation repeats in this manner for MODEs 1 and 2 during successive clock cycles.

The sample and invert block 1125 holds V_IL_INV after being reset or while CP is not asserted high, so that R3 is normally held low by the comparator 1127. R2 clocks latch 1123 so that R4 goes high indicating that V_IL has intersected LO_COMP at some point during the current clock cycle. If R4 is high at the clock edge (MODES 1 and 2), EP (EP′) is immediately reset low. If R4 is low at the clock edge (MODES 3 and 4), then EP (EP′) is asserted high until the intersection of V_IL_INV and LO_COMP causes R3 to go high resetting EP (EP′) back low. The sample and invert block 1125 is responsive to the CP pulse by sampling V_IL and initiating V_IL_INV at this bias voltage point. The sample and invert block 1125 then inverts V_IL in mirrored fashion so that V_IL_INV ramps at the same rate and in the opposite direction as V_IL as illustrated by the waveform 301 previously described. When V_IL_INV reaches LO_COMP, the comparator asserts R3 high to reset the latch 1129 to pull EP low and E high. R3 also resets the sample and invert block 1125 for the next cycle. Operation repeats in this manner for successive clock cycles for MODE 3 while R2 is not asserted.

When the external power source 201 is removed or not provided, then VIN goes low to zero and LO_COMP is pulled very low. V_IL_INV does not reach LO_COMP during successive clock cycles so that EP remains high while E remains low during MODE 4.

Although the present invention has been described in considerable detail with reference to certain preferred versions thereof, other versions and variations are possible and contemplated. Those skilled in the art should appreciate that they can readily use the disclosed conception and specific embodiments as a basis for designing or modifying other structures for carrying out the same purposes of the present invention without departing from the spirit and scope of the invention as defined by the following claim(s).

1. A control system for a shared inductor regulator, the shared inductor regulator including an inductor coupled between an input node and an intermediate node, a first switch coupled between the intermediate node and a reference node, a second switch coupled between the intermediate node and an output node, a third switch coupled between the intermediate node and a charge node, and a charge storage device coupled between the charge node and the reference node, said control system comprising:
a compensation system which provides an input compensation voltage based on a source voltage when received by the input node, which provides an output compensation voltage based on an output voltage developed on the output node, and which provides a charge compensation voltage based on a charge current through the charge storage device;
a sense system which receives a sense voltage indicative of inductor current through the inductor; and
a controller which is operative to control the first, second, and third switches based on the sense voltage, the input compensation voltage, the output compensation voltage, and the charge compensation voltage to regulate the output voltage to a predetermined voltage level, to regulate the charge current to a predetermined current level when the input compensation voltage indicates that the source voltage is above a minimum source level, and to maintain the source voltage at least at the minimum source level when provided to the input node.

2. The control system of claim 1, wherein:
said compensation system comprises:
a first amplifier which increases the charge compensation voltage when the charge current is below the predetermined current level; and
a second amplifier which decreases the input compensation voltage when the source voltage is below the predetermined voltage level; and
wherein said controller comprises:
a low block which receives the input compensation voltage and the charge compensation voltage and which provides a low compensation voltage based on a lower one of the input compensation voltage and the charge compensation voltage;
a first comparator which compares the sense voltage with the output compensation voltage; and
a second comparator which compares the sense voltage with the low compensation voltage.

3. The control system of claim 2, wherein said controller turns on the first switch and turns off the third switch coincident with a clock edge of a clock signal, wherein said controller turns off the first switch and turns on the second switch when the sense voltage reaches the output compensation voltage, and wherein said controller turns off the second switch and turns on the third switch when the sense voltage reaches the low compensation voltage.

4. The control system of claim 1, wherein the shared inductor regulator further includes a source node receiving the source voltage, a fourth switch coupled between the source node and the input node, and a fifth switch coupled between the charge node and the input node, said control system further comprising:
an inversion system which samples the sense voltage and provides an inverted sample voltage relative to a sense voltage sample when the sense voltage does not reach the input compensation voltage upon an assertion of an operative edge of a clock signal; and
wherein said controller is further operative to turn off the fourth switch and to turn on the fifth switch when the sense voltage does not reach the input compensation voltage upon the assertion of the operative edge of the clock signal, and to turn on the fourth switch and to turn off the fifth switch when the inverted sense voltage reaches the input compensation voltage.

5. The control system of claim 4, wherein said controller keeps the fourth switch off and keeps the fifth switch on while the input compensation voltage indicates that the source voltage is below a minimum source threshold which is less than the minimum source level.

6. The control system of claim 4, wherein said controller keeps the fourth switch off and keeps the fifth switch on when the inverted sense voltage does not reach the input compensation voltage by a next operative edge of the clock signal.

7. The control system of claim 1, wherein the shared inductor regulator further includes a source node receiving the source voltage, a fourth switch coupled between the source node and the input node, and a fifth switch coupled between the input node and the reference node, wherein:
while a low power mode signal is provided and while the output voltage is above a minimum output level, said controller is operative to turn the first and second switches off and the third switch on, to turn off the fourth switch and to turn on the fifth switch upon assertions of operative edges of a clock signal, and to turn on the fourth switch and to turn off the fifth switch when the sense voltage reaches a minimum one of the input compensation voltage and the charge compensation voltage; and
wherein while a low power mode signal is provided and when the output voltage is below the minimum output level during a cycle of the clock signal, said controller is further operative to keep the fourth switch on and the third and fifth switches off during the clock cycle, to turn on the second switch during an initial portion of the clock cycle, and to turn off the second switch and to turn on the first switch for a remainder of the clock cycle.

8. The control system of claim 7, wherein the initial portion of the clock cycle comprises a fixed duration.

9. The control system of claim 1, wherein the charge storage device comprises a rechargeable battery.

10. A method of operating a shared inductor regulator, wherein the regulator comprises an inductor coupled between an input node and an intermediate node, a charge storage device coupled between a charge node and a reference node, and a plurality of switches including a first switch coupled between the intermediate node and the reference node, a second switch coupled between the intermediate node and an output node, and a third switch coupled between the intermediate node and a charge node, the method comprising:
developing a plurality of compensation signals including an input compensation signal based on a source voltage when received by the input node, an output compensation signal based an output voltage developed on the output node, and a charge compensation signal based on a charge current which flows through the charge storage device;
sensing current through the inductor and providing a current sense signal; and
controlling the plurality of switches based on the current sense signal and the plurality of compensation signals to regulate the output voltage to a predetermined voltage level, to regulate the charge current to a predetermined current level when the source voltage is above a minimum source level, and to maintain the source voltage at least at the minimum source level when provided to the input node.

11. The method of claim 10, further comprising:
using the output compensation signal as an upper threshold for the current sense signal;
said developing a plurality of compensation signals further comprising:
increasing the charge compensation signal when the charge current is below a minimum charge level; and
decreasing the input compensation signal when the source voltage is below the minimum source level;
determining a lower one of the input compensation signal and the charge compensation signal and providing a low compensation signal; and
using the low compensation signal as a lower threshold for the current sense signal.

12. The method of claim 11, wherein said controlling the plurality of switches comprises:
closing the first switch and opening the third switch upon an operative edge of a clock signal;
opening the first switch and closing the second switch when the current sense signal reaches the output compensation signal; and
opening the second switch and closing the third switch when the current sense signal reaches the low compensation signal.

13. The method of claim 12, wherein the regulator further comprises a source node for receiving the source voltage when provided, wherein the plurality of switches includes a fourth switch coupled between the input node and the source node and a fifth switch coupled between the input node and the charge node, and wherein the method further comprises:
closing the fourth switch when the source voltage is provided;
detecting an additional mode when the sense signal does not reach the low compensation signal upon a next operative edge of the clock signal initiating a new clock cycle;
when the additional mode is detected, opening the second switch and keeping the third switch open for the new clock cycle;
when the additional mode is detected, opening the fourth switch and closing the fifth switch;
providing an inverted sense signal initiated from a value of the current sense signal at the next operative edge of the clock signal; and
closing the fourth switch and opening the fifth switch when the inverted sense signal reaches the low compensation signal.

14. The method of claim 13, wherein when the inverted sense signal does not reach the low compensation signal while the additional mode is detected, keeping the fourth switch opened and keeping the fifth switch closed.

15. The method of claim 12, wherein the regulator further comprises a source node for receiving the source voltage when provided, wherein the plurality of switches includes a fourth switch coupled between the input node and the source node and a fifth switch coupled between the input node and the reference node, and wherein the method further comprises:
receiving a low power mode signal indicating a low power mode;
during the low power mode and while the output voltage is above a minimum output level, turning the first and second switches off and the third switch on, turning off the fourth switch and turning on the fifth switch upon assertions of operative edges of a clock signal, and turning on the fourth switch and turning off the fifth switch when the current sense signal reaches the low compensation signal; and
during the low power mode and while the output voltage is below the minimum output level during a cycle of the clock signal, keeping the fourth switch on and the third and fifth switches off during the clock cycle, turning on the second switch during an initial portion of the clock cycle, and turning off the second switch and turning on the first switch for a remainder of the clock cycle.

16. An electronic device, comprising:
a power system, comprising:
an inductor coupled between an input node and an intermediate node;
a first switch coupled between said intermediate node and a reference node, a second switch coupled between said intermediate node and an output node, and a third switch coupled between said intermediate node and a charge node;
a charge storage device for coupling between said charge node and said reference node;
a compensation system which provides an input compensation voltage based on a source voltage when received by said input node, which provides an output compensation voltage based on an output voltage developed on said output node, and which provides a charge compensation voltage based on a charge current through said charge storage device;
a sense system which provides a sense voltage indicative of inductor current through said inductor; and
a controller which is operative to control said first, second, and third switches based on said sense voltage, said input compensation voltage, said output compensation voltage, and said charge compensation voltage to regulate said output voltage to a predetermined voltage level, to regulate said charge current to a predetermined current level when said input compensation voltage indicates that said source voltage is above a minimum source level, and to maintain said source voltage at least at said minimum source level when provided to said input node.

17. The electronic device of claim 16, further comprising a load coupled to said output node, wherein said load includes a processor and a memory.

18. The electronic device of claim 16, wherein:
said compensation system comprises:
a first amplifier which increases said charge compensation voltage when said charge current is below said predetermined current level; and
a second amplifier which decreases said input compensation voltage when said source voltage is below said predetermined voltage level;
wherein said controller comprises:
a low block which receives said input compensation voltage and said charge compensation voltage and which provides a low compensation voltage based on a lower one of said input compensation voltage and said charge compensation voltage;
a first comparator which compares said sense voltage with said output compensation voltage;
a second comparator which compares said sense voltage with said low compensation voltage; and
a control logic which turns on said first switch and turns off said third switch coincident with an operative edge of a clock signal, wherein said controller turns off said first switch and turns on said second switch when said sense voltage reaches said output compensation voltage, and wherein said controller turns off said second switch and turns on said third switch when said sense voltage reaches said low compensation voltage.

19. The electronic device of claim 18, further comprising:
a source node receiving said source voltage;
a fourth switch coupled between said source node and said input node;
a fifth switch coupled between said charge node and said input node;
an inversion system which samples said sense voltage and provides an inverted sample voltage relative to a sense voltage sample when said sense voltage does not reach said low compensation voltage upon an assertion of an operative edge of said clock signal; and
wherein said control logic is further operative to keep said third switch off while said sense voltage does not reach said low compensation voltage, to turn off said fourth switch and to turn on said fifth switch when said sense voltage does not reach said low compensation voltage upon said assertion of said operative edge of said clock signal, and to turn on said fourth switch and to turn off said fifth switch when said inverted sense voltage reaches said input compensation voltage.

20. The electronic device of claim 19, wherein said control logic keeps said fourth switch off and keeps said fifth switch on when said inverted sense voltage does not reach said low compensation voltage by a next operative edge of said clock signal.
